(19) United States
(12) Patent Application Publication
(10) Pub. No.: US 2008/0248297 A1
(43) Pub. Date: Oct. 9, 2008

(54) Cold transfer sticker and method for making the same

(76) Inventor: Chin-Fu Lee, Ta Ya Hsiang (TW)

Correspondence Address: PHILLIP LIU, 6980, WHITEOAK DR., RICHMOND, BC, V7EAZ9, CA

(21) Appl. No.: 12/078,833

(22) Filed: Apr. 7, 2008

(30) Foreign Application Priority Data
Apr. 9, 2007 (TW) 096112338

(51) Int. Cl. B41M 3/12; C09J 7/02; C09J 5/00

(52) U.S. Cl. 428/352; 427/147; 156/241

(57) ABSTRACT

A cold transfer sticker is made by preparing a releasing film and an oil layer with patterns and/or character is coated on the releasing film to form the sticker. The surface of the object is first cleaned and a glue layer is spread on the object. The sticker is attached onto the object and firmly pressed by a pressing tool. The releasing film is then removed from the sticker. The glue layer has compatible chemical characteristics with that of the oil layer and the object so as to securely combine the oil layer and the object. A protection layer is spread to the patterns and/or characters.

### FIELD OF THE INVENTION

The present invention relates to a cold transfer sticker which transfers patterns or characters to objects without using high temperature, and the method for making the cold transfer sticker.

### BACKGROUND OF THE INVENTION

Transfer stickers are used to put patterns or characters on surfaces of objects so as to attract customers' attention. Some objects have curved surfaces and conventional print processes are difficult to apply on the curved surfaces.

The conventional transfer stickers include heat transfer stickers and dry transfer stickers.

The heat transfer sticker is disclosed in Taiwan Publish No. 230757 and can be attached on a curved surface which is difficult for conventional printing methods. The heat transfer stickers includes a base layer with a leasing agent coated on the base layer, an oil layer is then coated on the leasing agent. The oil layer is made to include specific patterns and/or characters to be attached on the objects. A glue layer is coated on the oil layer and a leasing sheet is attached on the glue layer. When using the heat transfer sticker, the leasing sheet is first removed from the oil layer and the sticker is pressed on the surface of the object with desired temperature, the oil layer is then attached to the object. The base layer is then peeled off from the object and the patterns and/or characters are attached on the object.

This type of transfer sticker requires pressure and high temperature, and both of the two factors require specific devices which increase the cost of the products. Besides, the sticker has to be pressed on a plane surface to obtain a satisfied result. If the surface to be decorated is bumpy or not smooth, the result is not as good as expected.

Another conventional transfer sticker is dry transfer sticker which is disclosed in Taiwan Publish No. 180207 and includes a base layer with a leasing agent coated on the base layer, an oil layer is then coated on the leasing agent. The oil layer is made to include specific patterns and/or characters to be attached on the objects. A glue layer is coated on the oil layer and a leasing sheet is attached on the glue layer. However, the glue layer and the object to be decorated with the sticker are not the same, the oil layer cannot firmly attached on the object. It is experienced that if the object to be decorated is made by rubber or plastic with soft feature, the oil layer attached on the surface easily get cracks or even peel off from the object. Although the dry transfer sticker does not need high temperature to transfer the patterns and/or characters to the object. The result is still not satisfied and has room to be improved.

The present invention intends to provide a cold transfer sticker and the method for making the same, the cold transfer sticker does not need high temperature and can be firmly attached to the objects with hard or soft surface condition.

### SUMMARY OF THE INVENTION

The primary object of the present invention is to provide a cold transfer sticker which includes simple structure.

Another object of the present invention is to provide a cold transfer sticker which can be applied to hard or soft objects and requires no heat.

The present invention relates to a cold transfer sticker which includes a releasing film which is made by a soft plastic film applied with a releasing treatment and an oil layer with patterns and/or characters are coated on the releasing film. A glue layer is applied to the surface of the object and the releasing film. The glue layer has compatible chemical characteristics with that of the oil layer and the surfaces of the object. The sticker is attached on the surface of the object and the releasing film is peeled off from the sticker. The sticker is pressed on the object by assistance of a pressing tool. A protection layer is spread to the patterns and/or characters.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows the flow chart of the steps for making the cold transfer sticker of the present invention;

FIG. 2 shows the layers when the cold transfer sticker of the present invention is attached on an object by a glue layer;

FIG. 3 shows side view of the cold transfer sticker of the present invention;

FIG. 4 shows that the releasing film is removing from the cold transfer sticker of the present invention;

FIG. 5 is a partial cross sectional view to show that the cold transfer sticker of the present invention is attached to an object;

FIG. 6 is a partial cross sectional view to show that the cold transfer sticker of the present invention is attached to an object and the releasing film is peeling off from the sticker;

FIG. 7 shows that the cold transfer sticker of the present invention is about to be attached to an object;

FIG. 8 shows that a glue layer is spread on the object and the cold transfer sticker of the present invention is about to be attached to the area where the glue layer is spread on the object;

FIG. 9 shows that the releasing film is peeled off from the object, and

FIG. 10 shows that the charters of the oil layer are attached on the object.

### DETAILED DESCRIPTION OF THE PREFERRED EMBODIMENT

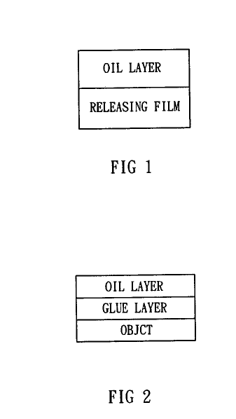

FIGS. 1 and 3 show the method for making the cold transfer sticker and the cold transfer sticker. The method of the of the present invention comprises the following steps:

step 1: preparing a soft plastic film such as Polyethylene Terephthalate (PET), Polyethylene (PE), Polypropylene (PP), Polyvinyl Chloride (PVC) and a releasing treatment is applied to a surface of the soft plastic film so as to form a releasing film 1 with desired thickness;

step 2: printing patterns and/or characters on the releasing film 1 to form an oil layer 3 with mono-color or multi-color or gradual-layer color;

step 3: combining the oil layer 3 and the releasing film 1, letting the releasing film 1 and the oil layer 3 dry for 12 hours, cutting the combination of the releasing film 1 and the oil layer 3 into pieces of the cold transfer stickers 10.

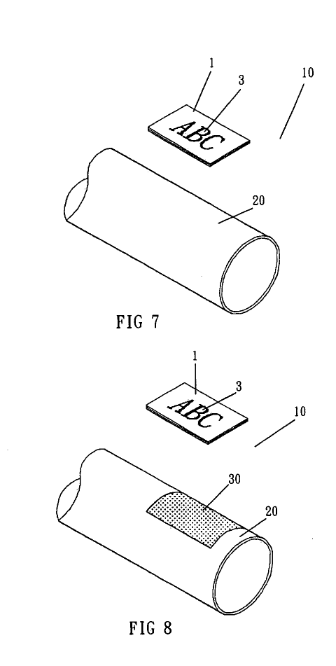

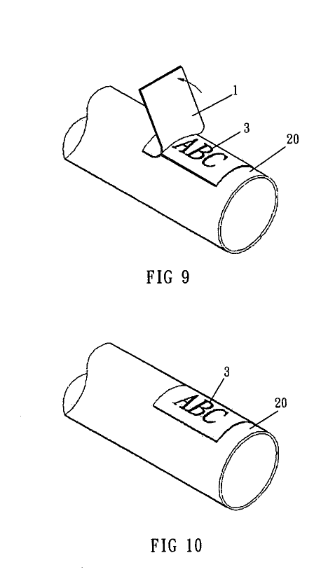

The use of the cold transfer stickers 10 is disclosed in FIGS. 2 and 4-10.

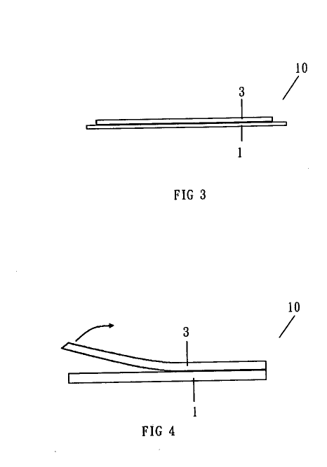

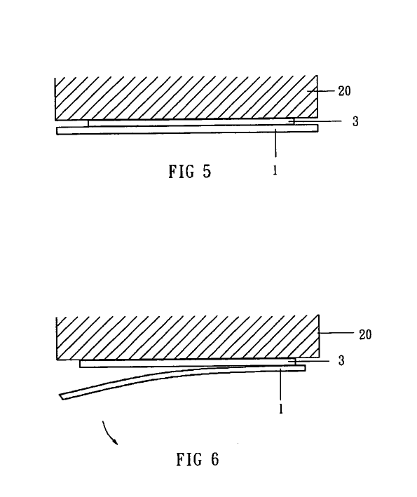

When using the cold transfer stickers 10, the object 20 to be attached with the cold transfer stickers 10 is applied with a surface cleaning treatment. Let the object 20 with the cleaned surface dry for 30 minutes. In this embodiment, the object 20 is a tubular object. A glue layer 30 is applied to the surface of the object 20 as shown in FIG. 8 and the glue layer 30 has compatible chemical characteristics with that of the oil layer 3 and the surfaces of the object 20. The glue layer 3 is oil-based liquid or glue. The cold transfer sticker 10 is attached to the object 20 as shown in FIG. 5 when 70% of the glue layer 30 is dry as shown in FIGS. 4 and 8. The attachment of the cold transfer sticker 10 is assisted by using a hand tool (not shown) which can be a pressing tool with soft ends. If the object 20 is an outsole with convex patterns, the pressing tool is a tool with concavities that are complimentary to the convex patters so that the cold sticker 10 can be fully matched with the outsole. A protection layer is spread to the patterns and/or characters transferred onto the object 20 such that the patterns and/or characters are protected by the protection layer. A drying process may also be applied to fix the patterns and/or characters. As shown in FIG. 10, the cold transfer sticker 10 can be attached to the object 20 without using high temperature.

The cold transfer sticker 10 of the present invention is thin and light in weight. The glue layer 30 is applied when the cold transfer sticker 10 is about to attached onto the object 20, the glue layer 30 so that the cold transfer sticker 10 of the present invention requires less number of manufacturing steps. Besides, the glue layer 30 has compatible chemical characteristics with that of the oil layer 3 and the object 20, so that the oil layer 3 and the object 20 can be firmly connected with each other.

The cold transfer sticker 10 of the present invention can be made at low cost because no heat device is required and the cold transfer sticker 10 can be used on soft or hard surface and even non-plane surface. The glue layer 30 is spread on the surface of the object 20 and ensures that the oil layer 3 is securely attached onto the object 20. The oil layer 3 transferred onto the soft object 20 does not crack or shift.

While we have shown and described the embodiment in accordance with the present invention, it should be clear to those skilled in the art that further embodiments may be made without departing from the scope of the present invention.

What is claimed is:

1. A method for making a cold transfer sticker, comprising:
preparing a base layer which is made by plastic material to form a releasing film;
preparing an oil layer with patterns and/or character, and
coating the oil layer on the releasing film.

2. The method as claimed in claim 1, wherein the releasing film is made by Polyethylene Terephthalate (PET), Polyethylene (PE), Polypropylene (PP), Polyvinyl Chloride (PVC).

3. Steps for making and using a cold transfer sticker, comprising:
step 1: preparing a soft plastic film and a releasing treatment being applied to a surface of the soft plastic film so as to form a releasing film;
step 2: printing patterns and/or characters on the releasing film and letting the releasing film and the oil layer dry, cutting the releasing film into pieces of the cold transfer stickers;
step 3: cleaning a surface of an object to be attached with the cold transfer sticker, and
step 4: spreading a glue layer to the surface of the object and the releasing film, the glue layer having compatible chemical characteristics with that of the oil layer and the surfaces of the object, letting the surface of the object dry and attaching the stickers on the surface of the object, removing the releasing film from the cold transfer sticker.

4. The steps as claimed in claim 3, wherein the releasing film is made by Polyethylene Terephthalate (PET), Polyethylene (PE), Polypropylene (PP), Polyvinyl Chloride (PVC).

5. The steps as claimed in claim 3, wherein the cold transfer sticker is attached to the object when 70% of the glue layer is dry.

6. A cold transfer sticker comprising:
a releasing film;
an oil layer with patterns and/or character coated on the releasing film, and
a glue layer coated on the oil layer and the glue layer having compatible chemical characteristics with that of the oil layer and a surface of an object to which the cold transfer sticker is to be attached.

7. The cold transfer sticker as claimed in claim 6, wherein the releasing film is made by Polyethylene Terephthalate (PET), Polyethylene (PE), Polypropylene (PP), Polyvinyl Chloride (PVC).

8. The cold transfer sticker as claimed in claim 6, wherein the glue layer is oil-based liquid or glue.
